(19) United States
(12) Patent Application Publication
(10) Pub. No.: US 2024/0165571 A1
(43) Pub. Date: May 23, 2024

(54) EDUCTOR

(71) Applicant: Levitronix GmbH, Zürich (CH)

(72) Inventors: Rennan HU, Zürich (CH); Samuel SCHNEIDER, Zürich (CH); Jürgen HAHN, South Grafton, MA (US); Natale BARLETTA, Zürich (CH)

(21) Appl. No.: 18/510,321

(22) Filed: Nov. 15, 2023

(30) Foreign Application Priority Data
Nov. 21, 2022 (EP) 22208652.2

(51) Int. Cl. B01F 25/312; B01F 23/50; B01F 35/21

(52) U.S. Cl. CPC B01F 25/31252; B01F 23/56; B01F 25/31243; B01F 25/312533; B01F 35/2113; B01F 2025/9321; B01F 2215/0422

(57) ABSTRACT

An eductor for mixing a primary fluid with a flowable secondary substance includes a primary inlet for the primary fluid, a secondary inlet for the secondary substance, an outlet and a suction chamber, A converging inlet nozzle is provided, which is arranged between the primary inlet and the suction chamber so that the primary fluid can flow from the primary inlet into the suction chamber. An outlet nozzle is provided between the suction chamber and the outlet, through which the primary fluid and the secondary substance can flow to the outlet, and the secondary inlet is provided at the suction chamber so that the secondary substance can flow from the secondary inlet into the suction chamber.

### CROSS-REFERENCE TO RELATED APPLICATION

This application claims priority to European Application No. 22208652.2, filed Nov. 21, 2022, the contents of which are hereby incorporated by reference.

### BACKGROUND

### Technical Field

The disclosure relates to an eductor for mixing a primary fluid with a flowable secondary substance according to the preamble of the independent patent claim.

### Background Information

An eductor is a device which is used for mixing a flowable secondary substance, for example a powder, into a primary fluid, for example a liquid such as water. The primary fluid is highly accelerated by a convergingly designed inlet nozzle and introduced into a suction chamber. Based on Bernoulli's equation, a negative pressure is created in the suction chamber, by which the secondary substance is sucked into the flow of the primary fluid. For this purpose, the suction chamber has a secondary inlet through which the secondary substance is sucked in and introduced into the flow of the primary fluid. Downstream of the suction chamber, an outlet nozzle is provided in which the primary fluid and the secondary substance mix with each other. The outlet nozzle is often designed as a Venturi nozzle.

According to a common design, the secondary substance is stored in a container, which is designed, for example, as a hopper. This container is placed on or connected to the secondary inlet of the eductor so that the secondary substance can be sucked from the container into the suction chamber.

Thus, the eductor fulfills two tasks, namely the addition of the secondary substance to the primary fluid and the mixing of the secondary substance with the primary fluid.

The flowing primary fluid is often referred to as motive flow, while the flowing secondary substance is referred to as suction flow.

Normally, the primary fluid is conveyed by a pump from a reservoir, such as a tank, through the eductor, in which the secondary substance is then sucked into the primary fluid. The mixture of the primary fluid and the secondary substance exits through the outlet nozzle and can then be recirculated to the reservoir for the primary fluid in order to achieve a continuous increase in the concentration of the secondary substance in this way, or the mixture of the primary fluid and the secondary substance is discharged from the process. Eductors are used both in discontinuous production processes, such as batch processes, and in continuous production processes.

In a sectional representation, FIG. 1 shows an eductor as known from the state of the art. In order to indicate that the representation in FIG. 1 is a device from the state of the art, the reference signs here are each marked with an inverted comma or a dash.

The eductor is designated in its entirety by the reference sign 1′. The eductor 1′ usually comprises three components from which it is assembled, namely a convergingly designed inlet nozzle 2′ for the primary fluid, a suction chamber 3′ and an outlet nozzle 4′, which is usually designed as a venturi nozzle

The inlet nozzle 2′ has a longitudinal axis which defines the center axis A′ of the eductor 1′. The inlet nozzle 2′ extends from a primary inlet 5′ into the suction chamber 3′. The outlet nozzle 4′ extends from the suction chamber 3′ to an outlet 6′ and has a longitudinal axis lying on the central axis A′, i.e., the longitudinal axis of the outlet nozzle 4′ is aligned with the longitudinal axis of the inlet nozzle 2′.

A secondary inlet 7′ is disposed at the suction chamber 3′, through which the secondary substance can be sucked into the suction chamber 3′.

For example, a tank is provided for the primary fluid. This tank is connected to the primary inlet 5′ via a feed line, whereby a pump, for example a centrifugal pump, is provided in the feed line, with which the primary fluid is conveyed from the tank through the inlet nozzle 2′. A reservoir 80′ is provided for the secondary substance, for example a hopper 80′, which is connected to the secondary inlet 7′ so that the secondary substance can flow from the reservoir 80′ into the suction chamber 3′. The reservoir 80′ is only indicated in FIG. 1. The outlet 6′ is connected to a discharge line which—depending on the respective process—recirculates the primary fluid mixed with the secondary substance to the tank or makes it available for removal at a system outlet. In the operating state, the primary fluid is conveyed through the inlet nozzle 2′ by the pump. In this process, the primary fluid in the inlet nozzle 2′ is strongly accelerated by its converging design, whereby a negative pressure is created in the suction chamber 3′, which sucks in the secondary substance from the reservoir 80′ through the secondary inlet 7′ into the suction chamber 3′. An intensive mixing of the secondary substance with the primary fluid then occurs in the outlet nozzle 4′.

As already stated, the eductor 1′ is usually assembled from the three components inlet nozzle 2′, suction chamber 3′ and outlet nozzle 4′. These separate components can be connected to each other by different methods, such as bonding, welding or screwing. The components are made, for example, from metals (such as cast iron or stainless steel) or also from plastics such as polyvinyl chloride (PVC), perfluoroalkoxy polymers (PFA), polypropylene (PP), or polyvinylidene fluoride (PVDF) available under the trade name Kynar®.

Eductors are also used in particular in the biotechnological and pharmaceutical industries, for example to mix a powder into a liquid, e.g., water or a nutrient liquid. Eductors are also used for mixing liquids as a secondary substance into a primary fluid that is different from it.

### SUMMARY

It has been determined that, in biotechnological and pharmaceutical industries, very high demands are often placed on the purity of processes. Processes often even have to be carried out under sterile conditions. Sterilizing the devices used for the process, for example by steam sterilization, is very often a time-consuming and cost-intensive factor. For this reason, there is an increasing tendency today to design components of the device as single-use parts for such processes in order to avoid time-consuming cleaning or sterilization processes or to reduce them to a minimum. For this reason, components or devices that come into direct contact with the biological substances or pharmaceutical substances during the process are often designed as single-use parts. The term “single-use parts” refers to parts or components that are used only once in accordance with their intended purpose. After use, the single-use parts are disposed of and replaced for the next application by new, i.e., not yet used, single-use parts.

In particular—but not only—with regard to single-use parts, it is an essential aspect that the single-use parts can be assembled in the simplest possible way with other components of the system, for example those which are designed for multiple use, i.e., which can be reused. The single-use parts should therefore be able to be replaced in a very simple way without the need for a great deal of assembly work.

Eductors known today require a relatively high effort to integrate them into mixing systems. The assembly of the inlet nozzle 2′, the suction chamber 3′ and the outlet nozzle 4′ as well as their integration into a mixing system are complex and require a lot of time, so that, for example, exchanging an eductor in a fluid or mixing system is a rather complex and time-consuming job.

Starting from this state of the art, it is therefore an object of the disclosure to propose an eductor for mixing a primary fluid with a flowable secondary substance, which can be integrated into a mixing system in a particularly simple and fast manner and can be exchanged in a simple manner.

The subject matter of the disclosure meeting this object is characterized by the features described herein.

According to the disclosure, an eductor for mixing a primary fluid with a flowable secondary substance is thus proposed, comprising a primary inlet for the primary fluid, a secondary inlet for the secondary substance, an outlet and a suction chamber, wherein a converging inlet nozzle is provided, which is arranged between the primary inlet and the suction chamber so that the primary fluid can flow from the primary inlet into the suction chamber, wherein an outlet nozzle is disposed between the suction chamber and the outlet, through which the primary fluid and the secondary substance can flow to the outlet, and wherein the secondary inlet is disposed at the suction chamber so that the secondary substance can flow from the secondary inlet into the suction chamber. According to the disclosure, the inlet nozzle, the suction chamber, and the outlet nozzle are designed as a one-piece unit.

In particular, it is also possible that the eductor is designed as one piece.

Due to the one-piece design of the unit made up of inlet nozzle, suction chamber, and outlet nozzle or of the entire eductor, the eductor no longer has to be assembled from several components but can be integrated as a monolithic device into a mixing system in a very simple and fast manner. In addition, no connections of individual components are required, for example by bonding, screwing, or welding, and no seals are required between individual components. The fact that the eductor according to the disclosure is free of such connections of adjacent components and seals between them is further advantageous with regard to a particularly hygienic design, such as is preferred for applications with high requirements for purity.

Preferably, the inlet nozzle, the suction chamber and the outlet nozzle are designed as a one-piece injection-molded part, or the entire eductor is designed a one-piece injection-molded part. The manufacture in an injection molding process enables a particularly cost-effective and economical manufacture of the eductor. In addition, the eductor is then necessarily designed in such a way that it can be demolded. i.e., removed from the mold after the injection molding process.

In addition, it is advantageous for the injection moldable design if the interior of the eductor, i.e., in particular also the suction chamber, is free of undercuts. Dead zones or stagnation zones for the flow, in which there is at most very little flow, or where there is only very weak mixing of the primary fluid with the secondary substance often form in undercuts or also at sharp-edged steps. Such dead zones, which exist for example in undercuts, at sharp edges or gradations, can be seen with an exemplary character in FIG. 1 in the areas designated by the reference sign T′. These dead zones T are particularly susceptible to material deposits, for example particle deposits. These dead zones T′ are also very difficult or very cumbersome to clean. Such dead zones T′ are avoided or at least much reduced due to the injection moldable design, which is also advantageous for a hygienic design of the eductor.

With regard to the most hygienic design possible, it is also a preferred measure if sharp edges or steps are avoided as far as possible in the interior of the eductor and in particular in the suction chamber. For example, transitions of the inner contour of the eductor can be designed to be obtuse-angled or rounded.

According to a preferred embodiment, the suction chamber has a bottom and a side wall which delimit the suction chamber, wherein the bottom is arranged opposite the secondary inlet, wherein the side wall is arranged at an angle of at least 90° relative to the bottom, and wherein the inlet nozzle terminates in the side wall. In this embodiment, the inlet nozzle thus terminates in the side wall, which delimits the suction chamber. The outlet surface of the inlet nozzle is arranged in the side wall so that the inlet nozzle does not project beyond the side wall and into the suction chamber. Due to this measure, a dead zone between the inlet nozzle and the bottom of the suction chamber can be avoided in particular.

It is another advantageous measure for reducing or avoiding dead zones to design the eductor in such a way that the bottom and the side wall are fully visible from the secondary inlet.

According to a preferred embodiment, the inlet nozzle has a longitudinal axis defining a center axis of the eductor, wherein the outlet nozzle has a longitudinal axis lying on the center axis of the eductor. In this embodiment, the longitudinal axis of the inlet nozzle is thus aligned with the longitudinal axis of the outlet nozzle, which is advantageous in terms of flow. Furthermore, it is preferred that the secondary inlet is arranged such that the secondary substance enters the suction chamber substantially at a right angle to the flow of the primary fluid.

Furthermore, it is preferred that the outlet nozzle has an entering edge which is arranged at the suction chamber opposite the side wall. This entering edge is preferably designed to be rounded.

Furthermore, it is preferred that the entering edge of the outlet nozzle has a distance from the center axis of the eductor which is at least the same size as the distance of the bottom of the suction chamber from the center axis. Particularly preferably, the distance of the entering edge from the center axis is at least approximately the same size as the distance of the bottom from the center axis. Thus, the bottom of the suction chamber is preferably at approximately the same level as the entering edge of the outlet nozzle. In doing so, a step between the bottom and the entering edge can be avoided, so that no dead zone can occur in this area either.

With regard to a hygienic design of the eductor, it is further preferred if the eductor has a plurality of inner surfaces which delimit the inlet nozzle, the suction chamber, and the outlet nozzle, wherein the inner surfaces have an average roughness value of at most 0.8 micrometers, preferably at most 0.4 micrometers, and particularly preferably at most 0.2 micrometers. Due to this particularly smooth design of the inner surfaces, material deposits or the adhesion of material to the inner surfaces can be at least significantly reduced

With regard to the installation of the eductor in a mixing system, it is advantageous if at least one pressure sensor is provided at or in the eductor. This can be used to determine or monitor the pressure conditions in the eductor, which can increase the operational reliability in a mixing system.

With regard to the arrangement of the at least one pressure sensor, the following areas are preferred, preferably, a pressure sensor is arranged in or at the side wall in which the inlet nozzle terminates. Furthermore, it is preferred if a pressure sensor is arranged in or at the suction chamber and adjacent to the secondary inlet. It is also preferred if a pressure sensor is arranged in or at the outlet nozzle, for example in the area of the inlet nozzle or—if the outlet nozzle is designed as a venturi nozzle—at the smallest cross-section of the venturi nozzle.

According to a further preferred embodiment, the eductor can have a connector for receiving a pressure sensor. The pressure sensor can then be, for example, a commercially available pressure sensor or a single-use pressure sensor that can be connected to the connector. For example, a luer lock, tri-clamp, or barb connector can be provided to connect the pressure sensor to the eductor.

Another preferred embodiment is that the pressure sensor is injected into the eductor. The pressure sensor is then injected into the eductor during injection molding, for example.

Another preferred variant with regard to pressure measurement is that the eductor has an integrated membrane to which an external pressure sensor is attached.

The eductor according to the disclosure can in particular also be designed as a single-use device for single use.

Further advantageous measures and embodiments of the disclosure are apparent from the present disclosure.

### BRIEF DESCRIPTION OF THE DRAWINGS

In the following, embodiments of the invention will be explained in more detail with reference to the drawings.

FIG. 1 illustrates a sectional representation of an eductor according to the state of the art,

FIG. 2 illustrates a perspective representation of an embodiment of an eductor according to the disclosure.

FIG. 3 illustrates the embodiment in a section along the center axis of the eductor.

FIG. 4 illustrates a detail of FIG. 3 in an enlarged representation,

FIG. 5 illustrates the embodiment in a section along the center axis of the eductor, but with different variants for the arrangement of at least one pressure sensor,

FIG. 6 illustrates the embodiment in a section along the center axis of the eductor but with a further variant for the pressure sensor,

FIG. 7 illustrates the embodiment in a section along the center axis of the eductor but with a connector for a pressure sensor, and

FIG. 8 illustrates a variant for the connector of a pressure sensor in a section along the center axis of the eductor and parallel to the inlet surface of the secondary inlet.

### DETAILED DESCRIPTION

As already mentioned, and explained, an eductor 1′ is represented in FIG. 1, which is known from the state of the art.

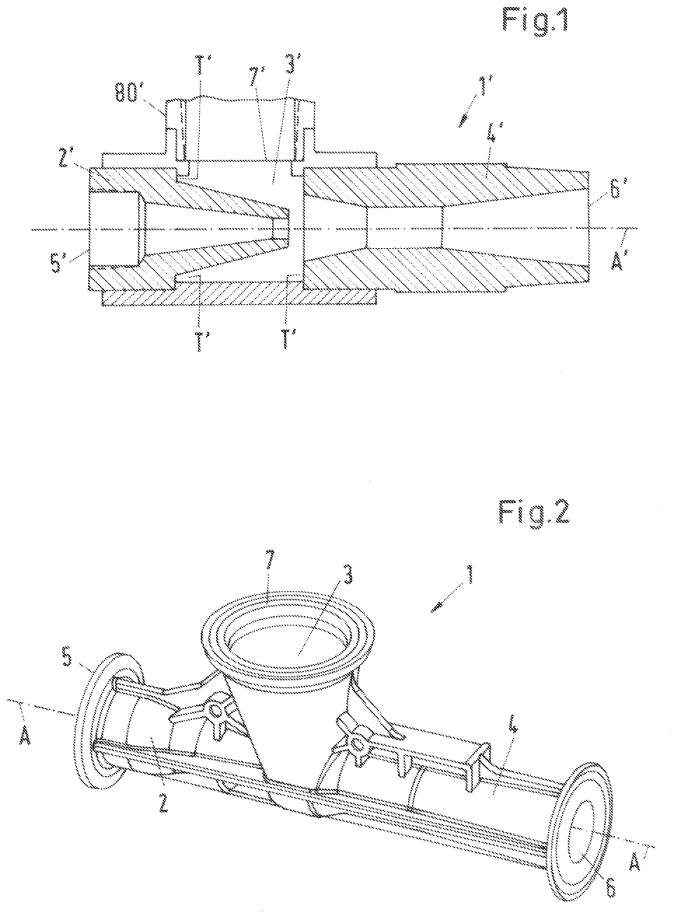

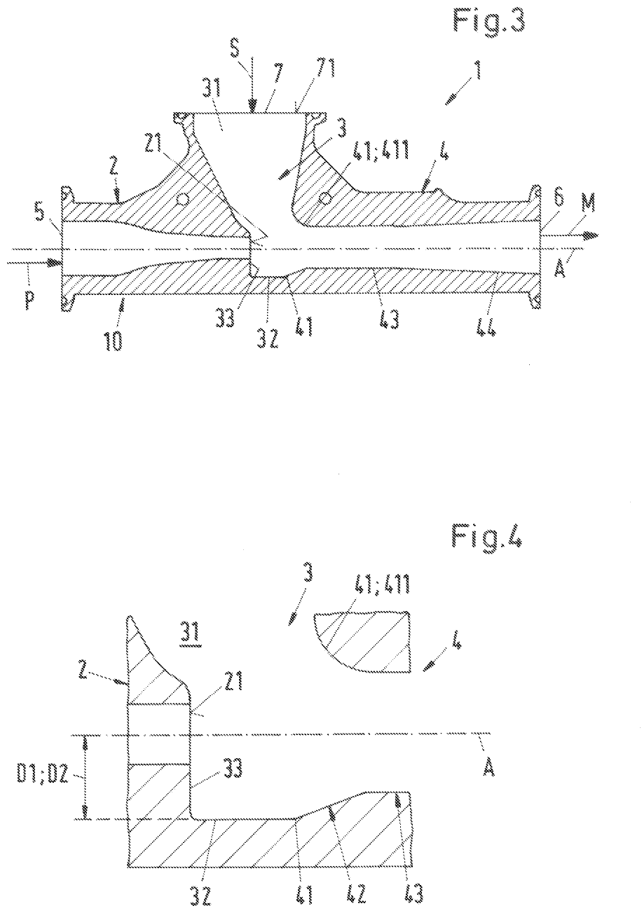

FIG. 2 shows in a perspective representation an embodiment of an eductor according to the disclosure, which is designated in its entirety by the reference sign 1. For a better understanding. FIG. 3 still shows the embodiment of the eductor 1 in a sectional representation, namely in a longitudinal section along a center axis A of the eductor 1.

The eductor 1 comprises a convergingly designed inlet nozzle 2 for a primary fluid, a suction chamber 3 for sucking in a flowable secondary substance, and an outlet nozzle 4, which is preferably designed as a venturi nozzle. In the operating state, the primary fluid intermixed with the secondary substance exits through the outlet nozzle 4 as a mixed fluid.

Usually, the primary fluid is a liquid, for example water. The flowable secondary substance is preferably a powder or a liquid different from the primary fluid.

The inlet nozzle 2 has a longitudinal axis defining the center axis A of the eductor 1. The outlet nozzle 4 has a longitudinal axis lying on the center axis A of the eductor 1, i.e., the inlet nozzle 2 and the outlet nozzle 4 are designed such that their longitudinal axes are aligned with each other.

Viewed in the direction of the center axis A, the suction chamber 3 is arranged between the inlet nozzle 2 and the outlet nozzle 4. The suction chamber 3 has a secondary inlet 7 for the secondary substance. The secondary inlet 7 forms an inlet surface 71 through which the secondary substance enters the eductor 1, as the arrow with the reference sign S in FIG. 3 indicates. The secondary inlet 7 is designed in such a way that the normal vector of the inlet surface 71 is perpendicular to the center axis A of the eductor 1. Opposite the secondary inlet 7, a bottom 32 is provided which delimits the suction chamber 3. Furthermore, a side wall 33 is provided which delimits the suction chamber 3, wherein the side wall 33 is arranged at right angles or at least approximately at right angles to the bottom 32. Between the side wall 33 and the secondary inlet 7, the suction chamber 3 has a hopper-shaped designed inlet area 31, which tapers as viewed from the secondary inlet 7 in the direction of the bottom 32.

The inlet nozzle 2 extends from a primary inlet 5 for the primary fluid to the side wall 33 of the suction chamber 3. In the operating state, the primary fluid flows through the primary inlet 5 in the direction of the center axis A as indicated by the arrow with the reference sign P in FIG. 3. The inlet nozzle 2 has an outlet surface 21 through which the primary fluid enters the suction chamber 3. The outlet surface 21 has a normal vector which lies on the center axis A. The outlet surface 21 of the inlet nozzle 2 is arranged in the side wall 33 of the suction chamber 3, so that the inlet nozzle 2 does not project beyond the side wall 33 but ends flush with the side wall 33. In particular, therefore, the inlet nozzle 2 does not project into the suction chamber 3. Due to this embodiment, dead zones in the suction chamber 3 between the inlet nozzle 2 and the bottom 32 are avoided.

The outlet nozzle 4 extends from the suction chamber 3 to the outlet 6. In the operating state, the mixed fluid, i.e., the primary fluid mixed with the secondary substance, exits the eductor 1 through the outlet 6 as indicated by the arrow with the reference sign M in FIG. 3. For a better understanding. FIG. 4 still shows a detail of FIG. 3 in an enlarged representation. In this detail, in particular the transition from the suction chamber 3 to the outlet nozzle 4 is represented enlarged.

The outlet nozzle 4 has an entering edge 41 which is arranged directly at the bottom 32 of the suction chamber 3. The entering edge 41 is arranged at the suction chamber 3 opposite the side wall 33 and extends along the entire lateral extent of the suction chamber 3 around the center axis A. In the region of the inlet area 31 of the suction chamber 3, the entering edge 41 is designed to be strongly rounded as a rounding 411 in order to avoid a sharp edge and to enable the smoothest possible transition from the inlet area 31 of the suction chamber 3 into the outlet nozzle 4.

The outlet nozzle 4 is preferably designed as a venturi nozzle. Downstream of the entering edge 41 of the outlet nozzle 4, a converging section 42 therefore follows in which the cross-sectional area of the outlet nozzle 4 available for the flow is reduced to a minimum value. Downstream of the converging section 42, a mixing section 43 can be provided in which the cross-sectional area remains substantially constant. In the mixing section 43, the inner diameter of the outlet nozzle 4 is substantially constant. The mixing section 43 serves to mix the primary fluid with the secondary substance. A diverging section 44, which serves as a diffuser and extends to the outlet 6 of the outlet nozzle 4, adjoins the mixing section 43 downstream. The cross-sectional area available for the flow increases in the diverging section 44, as viewed in the flow direction.

As can be seen in particular in FIG. 4, the rounding 411 of the entering edge 41 of the outlet nozzle 4 disposed at the inlet area 31 can extend to the beginning of the mixing section 43, as viewed in the flow direction. The converging section 42 is designed substantially in the shape of a truncated cone in the area of the bottom 32 of the suction chamber 3.

As can be seen in particular in FIG. 4, the entering edge 41 of the outlet nozzle 4 has, where it adjoins the bottom 32 of the suction chamber 3, a distance D1 from the center axis A of the eductor 1 which is at least the same size as the distance D2 of the bottom 32 of the suction chamber 3 from the center axis A of the eductor 1. In the embodiment described here, the distance D1 of the entering edge 41 from the center axis A of the eductor 1 is the same size as the distance D2 of the bottom 32 of the suction chamber 3 from the center axis A.

With respect to the normal operating position which is represented in FIG. 3 and FIG. 4, the bottom 32 of the suction chamber 3 is thus at the same level as the entering edge 41 of the outlet nozzle 4 adjacent to it. Thus, there is no boundary surface of the suction chamber 3 that lies below (with respect to the representation in FIG. 3 and FIG. 4) the entering edge 41 of the outlet nozzle 4. Due to this embodiment, the formation of such dead zones T between the suction chamber 3 and the outlet nozzle 4 as represented, for example, in FIG. 1, can be avoided.

As can be seen in particular in FIG. 3, all boundary surfaces of the suction chamber 3. i.e., in particular also the bottom 32 and the side wall 33 of the suction chamber 3, are fully visible from the secondary inlet 7 in the embodiment described here. Thus, there are no undercuts or covered areas in which dead zones could form.

According to the disclosure, the inlet nozzle 2, the suction chamber 3 and the outlet nozzle 4 are designed as a one-piece unit 10. In the embodiment represented in FIG. 3, the entire eductor 1 is designed as one piece.

The one-piece unit 10 has a monolithic design, i.e., it is not composed of multiple components, but it is a single piece. Consequently, the one-piece unit 10 is free of bondings, screw connections, welding seams, seals, and contacts between adjacent components.

The inlet nozzle 2, the suction chamber 3 and the outlet nozzle 4 are designed as cavities in the one-piece unit 10. The primary inlet 5, the secondary inlet 7 and the outlet 6 are each designed as an opening in the one-piece unit 10.

Particularly preferably, the one-piece unit 10 is designed as a one-piece injection molded part. Thus, the one-piece unit 10 is preferably manufactured by an injection molding process. Since the suction chamber 3 in particular is designed without undercuts and neither the inlet nozzle 2 nor the outlet nozzle 4 extend into the suction chamber, the one-piece unit 10 can be designed to be demoldable. Thus, the one-piece unit 10 can be easily manufactured in an injection molding process. Only one injection molding process is required to produce the one-piece unit.

Of course, other methods for manufacturing the one-piece unit 10 are also suitable, for example, methods of additive manufacturing such as the method designated as 3D printing.

Preferably, the one-piece unit 10 is made of a plastic. For example, the one-piece unit 10 can be injection molded from one of the following plastics: polyvinyl chloride (PVC), perfluoroalkoxy polymers (PFA), polypropylene (PP), or polyvinylidene fluoride (PVDF) available under the trade name Kynar®.

In particular, but not only with regard to applications in the biotechnological and pharmaceutical industries, the eductor 1 preferably has a hygienic design. Hygienic design refers to a design in which dead zones are avoided as far as possible. In addition, material deposits on the inner walls or on the inner surfaces of the one-piece unit 10 delimiting the suction chamber 3, the inlet nozzle 2 and the outlet nozzle 4 are to be avoided or at least minimized as far as possible.

With regard to this hygienic design, the following measures are preferred for the design of the eductor 1:

The suction chamber 3 does not have a boundary surface that lies below (with respect to the representation in FIG. 3 and FIG. 4) the lower entering edge 41 of the outlet nozzle 4 according to the representation.

All surfaces which delimit the suction chamber 3 are visible as viewed from the secondary inlet 7.

All inner surfaces of the one-piece unit 10 which delimit the inlet nozzle 2, the suction chamber 3 and the outlet nozzle 4 are designed with an average roughness value of at most 0.8 micrometers, preferably at most 0.4 micrometers and more particularly at most 0.2 micrometers.

Sharp edges are avoided as far as possible inside the one-piece unit 10.

With regard to the integration of the eductor 1 into a mixing system for mixing the primary fluid with the secondary substance, for example a powder, it can be advantageous if the eductor 1 has one or more sensors for process monitoring. Thus, it can be advantageous, for example, if at least one pressure sensor is provided at or in the eductor 1, with which, for example, the suction power of the eductor 1 can be determined. In this way, undesired or even dangerous operating states in the mixing system can be detected or corrected or avoided. Such an undesired operating state is, for example, an overpressure in the suction chamber 3. Such an overpressure can have different causes and can, for example, lead to a leakage, in which a leakage flow exits the eductor 1 through the secondary inlet 7.

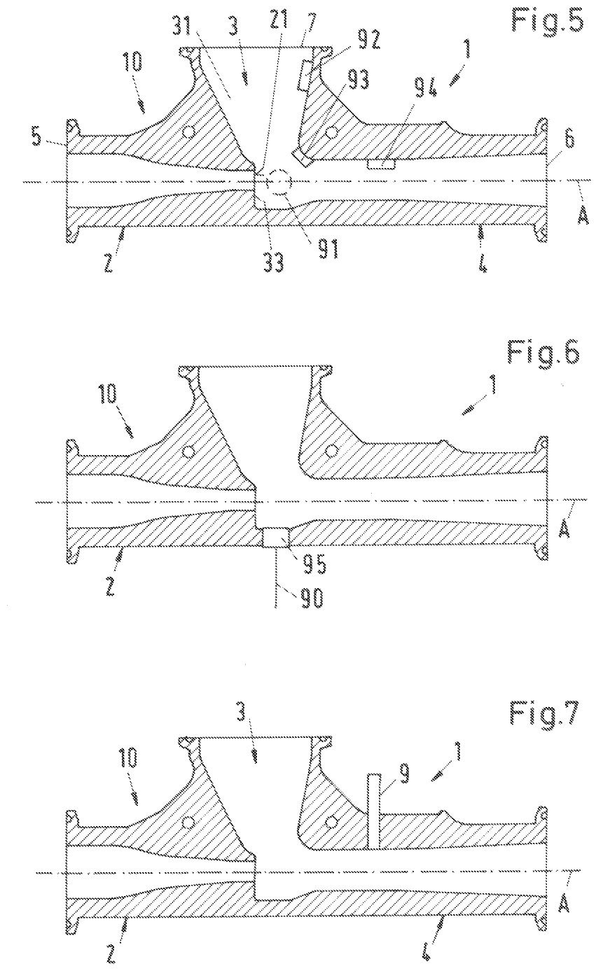

Referring to FIG. 5 to FIG. 7, some possibilities for providing at least one pressure sensor at or in the eductor 1 are explained in a non-exhaustive list. Apart from the pressure sensors, the representations in FIG. 5 to FIG. 7 correspond in each case to the representation in FIG. 3.

FIG. 5 shows four pressure sensors 91, 92, 93, 94, which can be used, for example, to determine the suction power of the eductor 1 in the operating state. It is understood that not all four pressure sensors 91-94 need to be provided, it is usually sufficient if at least one of the pressure sensors 91-94 is provided. The representation of the pressure sensors 91-94 is also to be understood as schematic, because the pressure sensors 91-94 are preferably designed and arranged such that they do not extend, or at least do not extend substantially, into the interior of the one-piece unit 10. For example, the pressure sensors can be injected at the respective location during the injection molding process by which the one-piece unit 10 is manufactured (see, for example, FIG. 6), so that they do not extend into the interior of the one-piece unit 10, but are arranged flush with the respective inner surface, for example.

As represented in FIG. 5, the pressure sensor 91 is arranged in or at the side wall 33 in which the inlet nozzle 2 terminates. The pressure sensor 91 is then preferably arranged with respect to the circumferential direction of the suction chamber 3 at a distance from the outlet surface 21 of the inlet nozzle 2, for example at the same height but offset by about 90° with respect to the circumferential direction from the outlet surface 21 (see also FIG. 8). The pressure sensor 91 can also be arranged immediately adjacent to the outlet area 21 of the inlet nozzle 2, namely in the transition area from the side wall 33 to the inlet area 31.

The pressure sensor 92 is arranged in or at the suction chamber 3 and adjacent to the secondary inlet 7, more specifically in or at the inlet area 31 of the suction chamber 3.

The pressure sensor 93 is arranged in or at the entering edge 41 of the outlet nozzle 4, preferably in or at the rounding 411.

The pressure sensor 94 is arranged in or at the outlet nozzle 4, preferably in the mixing section 43, or in the area in which the outlet nozzle 4 has its smallest cross-sectional area.

FIG. 6 shows a variant in which a pressure sensor 95 is injected into the bottom 32 of the suction chamber 3. For example, the pressure sensor 95 can be a commercially available single-use pressure sensor 95 which is injected during the manufacture of the one-piece unit 10. The measurement values of the pressure sensor 95 can be transmitted to an evaluation unit (not shown) via a signal connection 90.

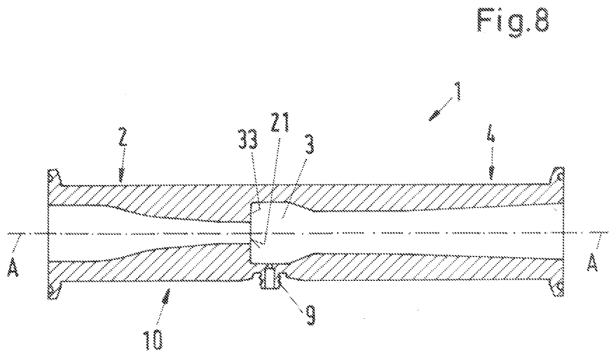

FIG. 7 shows a variant in which the eductor 1 has a connector 9 which is designed for receiving a pressure sensor (not represented in FIG. 7). Here, the connector 9 is designed in such a way that it is applied with the pressure prevailing in the eductor 1. Preferably, the connector 9 is provided at the outlet nozzle 4, for example in the mixing section 43 of the outlet nozzle 4. The connector 9 is designed in such a way that it can receive or be connected to an external pressure sensor. For example, the external pressure sensor can be a commercially available pressure sensor with a luer lock connector, whereby the connector 9 is connected to the external pressure sensor via the luer lock. Further variants for the connection of the pressure sensor to the eductor are, for example, the design as a tri-clamp or barb connector. Of course, the external sensor can also be designed as a single-use sensor.

FIG. 8 shows a variant for the connector 9 of a pressure sensor 91 (not represented in FIG. 8) in a section along the center axis of the eductor 1 and parallel to the inlet surface 71 of the secondary inlet 7, i.e., compared to the representation in FIG. 3, in FIG. 8 the section plane is rotated by 90° about the center axis A. The direction of view in FIG. 8 is from the secondary inlet 7 to the suction chamber 3. In this variant, the pressure sensor 91 is provided at the same height of the suction chamber 3 as the outlet surface 21 of the inlet nozzle 2 but offset by about 90° with respect to the circumferential direction from the outlet surface 21. The connector 9 is designed as a luer lock to which the pressure sensor 91 can be connected.

Furthermore, it is possible that the eductor 1 has an integrated membrane which is arranged and designed in such a way that it is applied with the pressure prevailing in the eductor 1. Then, this integrated membrane interacts with an external pressure sensor to determine the pressure. For this purpose, commercially available single-use in-line membranes for connection to pressure sensors are suitable, for example.

Furthermore, it is possible to provide an in-line sensor in or downstream of the outlet nozzle 4, with which the pressure can be determined. The in-line sensor can be designed with a tri-clamp connector, for example.

Other variations are also possible for sensors that can be provided in or at the eductor 1. For the determination of the suction power of the eductor 1 with which the secondary substance is sucked in through the secondary inlet 7, and/or for the detection of a leakage flow which exits the eductor 1 through the secondary inlet 7, and/or for the detection of an overflow, a flow sensor or a level sensor or a sensor for conductivity measurement can be provided, for example. These sensors are preferably arranged adjacent to the secondary inlet 7, for example in or at the inlet area 31 of the suction chamber 3. For example, an ultrasonic sensor or a mass flow sensor is suitable as a flow sensor.

According to a preferred embodiment, the one-piece unit 10 or the eductor 1 are designed as a single-use device for single use.

The term “single-use device” refers to those components or parts which are designed for single-use, i.e., which can be used only once as intended and are then disposed of. For a new application, a new, previously unused single-use part must then be inserted. When configuring or designing the one-piece unit 10 or the eductor 1 as a single-use device, substantial aspects are therefore that the single-use device can be manufactured as simply and economically as possible, generate few costs and can be manufactured from materials, for example plastics, that are available at the lowest possible price. It is another substantial aspect that the single-use device, i.e., in this case the one-piece unit 10 or the eductor 1, can be assembled as easily as possible with other components, for example in a mixing system. The single-use device should therefore be able to be replaced very easily without the need for high assembly effort. Particularly preferably, the single-use device should be able to be replaced without the use of tools.

It is also an important aspect that the single-use device can be disposed of as easily as possible after use. For this reason, preference is given to materials that cause the least possible environmental impact, in particular also during disposal.

It is a further substantial aspect that the one-piece unit 10 designed as a single-use device or the eductor 1 designed as a single-use device must be sterilizable for certain fields of application. In this regard, it is particularly advantageous if the single-use device 1 or 10, respectively, is gamma-sterilizable. In this type of sterilization, the element to be sterilized is applied with gamma radiation. The advantage of gamma sterilization, for example in comparison with steam sterilization, is in particular that sterilization can also take place through the packaging. For single-use devices in particular, it is a common practice that the parts are placed in the packaging after they are manufactured and then stored for a period of time before being shipped to the customer. Sterilization then usually takes place shortly before delivery to the customer. In such cases, sterilization takes place through the packaging, which is not possible with steam sterilization or other processes.

With regard to the single-use device 1, 10, it is generally not necessary for them to be sterilizable more than once. This is a great advantage, particularly in the case of gamma sterilization, because the application of gamma radiation to plastics can lead to degradation, so that multiple gamma sterilization can render the plastic unusable.

Since sterilization under high temperatures and/or under high (steam) pressure can usually be dispensed with for single-use devices, less expensive plastics can be used, for example those that cannot withstand high temperatures or that cannot be subjected to multiple high temperature and pressure levels.

Considering all these aspects, it is therefore preferred to use such plastics that can be gamma-sterilized at least once for the manufacture of the single-piece unit 10 or the eductor 10, respectively. The materials should be gamma-stable for a dose of at least 40 kGy to enable a single gamma sterilization. In addition, no toxic substances should be generated during gamma sterilization. In addition, it is preferred that all materials that come into contact with the substances to be mixed or the intermixed substances meet USP Class VI standards.

For manufacturing the eductor 1 or the one-piece unit 10, respectively, the following plastics, for example, are also suitable in addition to the plastics already mentioned: polyethylene (PE), low density polyethylene (LDPE), ultra low density polyethylene (ULDPE), ethylene vinyl acetate (EVA), polyethylene terephthalate (PET), polyvinylidene fluoride (PVDF), acrylonitrile butadiene styrene (ABS), polyacryl, polycarbonate (PC).

What is claimed is:

1. An eductor for mixing a primary fluid with a flowable secondary substance comprising:
a primary inlet for the primary fluid;
a secondary inlet for the secondary substance;
an outlet;
a suction chamber;
a converging inlet nozzle arranged between the primary inlet and the suction chamber so that the primary fluid is capable of flowing from the primary inlet into the suction chamber; and
an outlet nozzle between the suction chamber and the outlet, through which the primary fluid and the secondary substance are capable of flowing to the outlet, and the secondary inlet is disposed at the suction chamber so that the secondary substance is capable of flowing from the secondary inlet into the suction chamber, and the inlet nozzle, the suction chamber and the outlet nozzle are a one-piece unit.

2. The eductor according to claim 1, wherein the inlet nozzle, the suction chamber and the outlet nozzle are a one-piece injection-molded part.

3. The eductor according to claim 1, wherein the suction chamber has a bottom and a side wall which delimit the suction chamber, the bottom is arranged opposite the secondary inlet, the side wall is arranged at an angle of at least 90° relative to the bottom, and the inlet nozzle terminates in the side wall.

4. The eductor according to claim 3, wherein the bottom and the side wall are fully visible from the secondary inlet.

5. The eductor according to claim 1, wherein the inlet nozzle has a longitudinal axis defining a center axis of the eductor, and the outlet nozzle has a longitudinal axis lying on the center axis of the eductor.

6. The eductor according to claim 5, wherein the outlet nozzle has an entering edge which is arranged at the suction chamber opposite the side wall.

7. The eductor according to claim 6, wherein the entering edge of the outlet nozzle has a distance from the center axis of the eductor which is at least the same size as a distance of a bottom of the suction chamber from the center axis.

8. The eductor according to claim 1, wherein a plurality of inner surfaces delimit the inlet nozzle, the suction chamber and the outlet nozzle, and the plurality of inner surfaces have an average roughness value of at most 0.8 micrometers.

9. The eductor according to claim 1, wherein at least one pressure sensor is disposed at or in the eductor.

10. The eductor according to claim 9, wherein a pressure sensor is arranged in or at a side wall in which the inlet nozzle terminates.

11. The eductor according to claim 9, wherein the at least one pressure sensor is arranged in or at the suction chamber and adjacent to the secondary inlet.

12. The eductor according to claim 9, wherein the at least one pressure sensor is arranged in or at the outlet nozzle.

13. The eductor according to claim 9, wherein the eductor has a connector to receive a pressure sensor.

14. The eductor according to claim 9, wherein the at least one pressure sensor is injected into the eductor.

15. The eductor according to claim 1, designed as a single-use device for single use.

16. The eductor according to claim 1, wherein a plurality of inner surfaces delimit the inlet nozzle, the suction chamber and the outlet nozzle, and the plurality of inner surfaces have an average roughness value of at most 0.4 micrometers.

17. The eductor according to claim 1, wherein a plurality of inner surfaces delimit the inlet nozzle, the suction chamber and the outlet nozzle, and the plurality of inner surfaces have an average roughness value of at most 0.2 micrometers.
